(19) United States
(12) Patent Application Publication
(10) Pub. No.: US 2003/0204573 A1
(43) Pub. Date: Oct. 30, 2003

(54) Method of providing a web user with additional context-specific information

(76) Inventors: Andre Beck, Woodbridge, NJ (US); Markus Hofmann, Fair Haven, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/135,920

(22) Filed: Apr. 30, 2002

(51) Int. Cl. G06F 15/16

(52) U.S. Cl. 709/218

(57) ABSTRACT

Additional context-specific information is made available to a user at a client machine as the user at a client makes a request and retrieves information from a content provider on the Web. Such additional information is either generated or separately retrieved based on an analysis of the content of the response from a content provider to a request from the client and, optionally, the original request from the client. If this analysis indicates that additional context-specific information is needed, the original response from the content provider is provided to the client with an indication that such additional context-specific information is available. While the original requested information is being delivered to the client and viewed by the user, the additional information is either being generated or retrieved in the background and stored in a Web cache or at a Web server so that if and when the user requests that additional information after reviewing the original response, it is immediately available from a nearby repository. The additional context-specific information is made available to the user by, for example, modifying the original response provided to the user to include a hyperlink to the additional context-specific information, opening a new window or frame that includes the context-specific information, or adding the additional information directly to the untransformed content in the original response.

### TECHNICAL FIELD

This invention relates to providing Web content to an end user on the Internet.

### BACKGROUND OF THE INVENTION

The Internet as of today is still mostly governed by the “end-to-end” principle which demands that the network itself be kept as simple as possible and that all intelligence resides at the end-systems. This principle has proven to be very successful and beneficial for the evolution of the Internet. Despite its success, recently more application-specific functionality has been moving into the network, in particular to the edges of the network. Deployment of network caches and content-aware switches are examples of this kind of functionality. It helps accelerating the delivery of static web pages by moving content closer to the user. However, margins for such basic delivery services are getting slimmer and service providers have to take advantage of opportunities to provide new value-added content services for differentiation and additional revenue. Examples of such services include, but are not limited to, content filtering, content adaptation, dynamic and personalized content assembling, ad insertion and virus scanning.

While most of these services could also be installed on and provided at the client machine itself in order to adhere to the end-to-end principle, there are reasons to move them to the network edge. The typical Internet user of today, for example, can be best described as a non-technical consumer who wants to use the latest Internet technology without having to worry about technical matters like software installations or updates. Furthermore, new types of Internet access devices likes PDAs and mobile telephones may not always have the processing power that is necessary to run the software for providing value-added services. Other Internet appliances may only be capable of running hard-coded software so that software upgrades would not be possible at all.

The present inventors, in an article entitled “Enabling the Internet to Deliver Content-Oriented Services,” Proceedings of Sixth International Workshop on Web Caching and Content Distribution (WCW), Boston, Mass., Jun. 20-22, 2001, which is incorporated by reference herein, describe in detail a service platform architecture that extends the existing network edge infrastructure towards a flexible and open platform for a variety of new content services. This platform makes use of and extends existing intermediary devices, such as caching proxies and content-aware switches, enabling them to perform specific tasks on the application-layer content that is routed through them.

Using the afore-noted service platform architecture in an intermediary device at the edge of the network to provide new services is desirable.

### SUMMARY OF THE INVENTION

In accordance with the present invention, the service platform architecture is used to make available to a user at a client machine additional context-specific information as the user makes a request and retrieves information from a content provider on the Web. Such additional information is either generated or separately retrieved based on an analysis of the content of the response from a content provider to a request from the client and, optionally, the original request from the client. If such analysis indicates that additional context-specific information is needed, the original response to the request containing untransformed content is provided to the client with an indication that such additional context-specific information is available. While the original requested information is being provided to the client and viewed or otherwise processed by the user, the additional information is either being generated or retrieved in the background and stored in a Web cache or at a Web server so that if and when the user requests that additional information, it is immediately available from a nearby repository. Thus, if it is the type of information that must be retrieved from a distant Web server, it is made available from a nearby cache or Web server if the user requests it after viewing the originally requested Web page. Further, if it is the type of information that must be generated, it is immediately available without the delay that would otherwise occur if it were first generated in response to a user request after the user views the original Web page. There are various ways to make the additional context-specific information available to the user of the client machine. These include, by way of example, modifying the original response provided to the user to include a hyperlink to the additional context-specific information, opening a new window that includes that information, opening an additional frame together with the original information, or adding the additional information to original requested information.

### BRIEF DESCRIPTION OF THE DRAWING

FIG. 1 is a block diagram of a network showing a client machine, a content provider connected to the Internet, and an ISP network that utilizes an intermediary device that analyzes requests passing through it from the client machine and responses to the requests from a content provider in order to make additional context-specific information available to the user of the client machine, in accordance with the present invention;

FIG. 2 is a block diagram of the service platform architecture of an embodiment of the intermediary device in FIG. 1;

FIGS. 3 and 4 together are a flowchart showing the steps associated with providing a Web user with additional context-specific information, in accordance with the invention;

FIG. 5 is an example of an original Web page together with an additional window that has been opened in a user's browser, in accordance with the invention, to provide the user with additional information related to the content of the information in the original page displayed by the browser;

FIG. 6 is an example of an original Web page in German delivered to a user's browser, that has been modified to include two hyperlinks to other Web pages that each contain translations of the original page; and

FIG. 7 is an example of the English translation of the original Web page of FIG. 6, which is formulated by the intermediary when the HTML-formatted original Web page transits the intermediary, and which is delivered to the user's browser when the user selects the hyperlink in that original Web.

### DETAILED DESCRIPTION

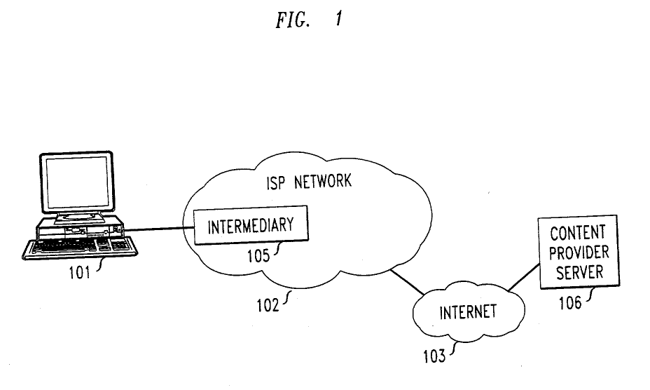

With reference to FIG. 1, a client 101 is shown connected to an Internet Service Provider (ISP) network 102, which provides access to the Internet 103. The client 101, which is running a conventional browser program (not shown), in response to a user's input, can issue a request and receive a response from a particular content provider's server 106 that has received that request. An intermediary 105, at the edge of the network within the ISP network, as described in the afore-noted and incorporated paper, can provide additional intelligent value-added services by operating on the request and response message stream passing through it going to and coming from the content provider's server 106. In accordance with the present invention, the content of a response to a request from a content provider is analyzed to determine whether additional context-specific information should be made available to the user when the requested response is delivered to the user's client. An intermediary of the type described in the afore-noted and incorporated article can provide the mechanism for implementing this value-added service for the described embodiment of the present invention.

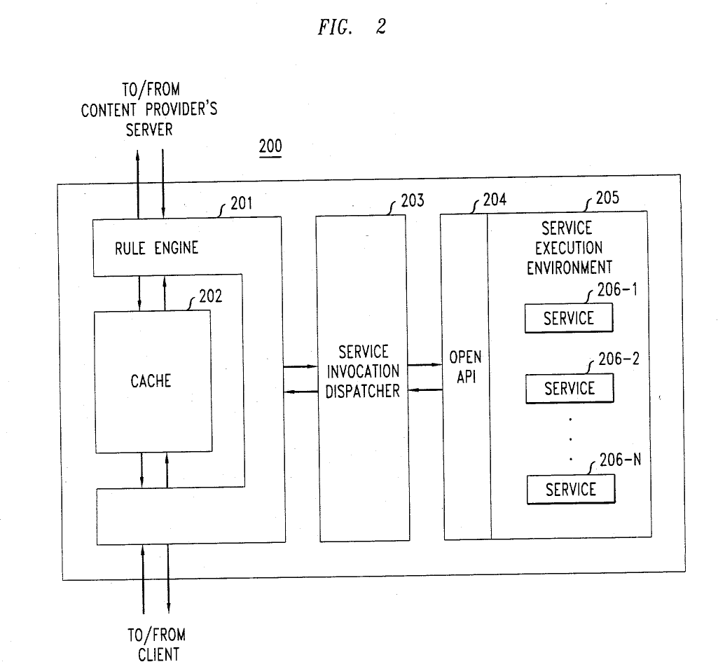

FIG. 2 shows a block diagram of an embodiment of an intermediary 200 that can provide the value-added service of the present invention. The intermediary 200 includes a rule engine 201, a cache 202, a service invocation dispatcher 203, an open API 204, and a service execution environment 205. The service invocation dispatcher 203 invokes one or more different service modules 206-1-206-N depending upon which services are triggered in response to an analysis by the rule engine of the responses to the requests, and optionally the associated requests, that pass through the intermediary 200. In order to determine which service modules 206 are to be invoked, rules are provided by the parties for which the particular service modules may be executed that specify the conditions under which a response from a content provider's server shall trigger the execution of one or more service modules. A particular service module 206 process is invoked only for those server responses that match those rules associated with the triggering of that service module.

As described in the above-noted article, the rule engine can operate on rules provided by external rule authors that define rule conditions that exactly specify when a particular service module is to be invoked. A standardized rule specification language has been proposed and submitted to the IETF standards body for the exchange of rules between rule authors and service platforms (see, e.g., A. Beck, M. Hofmann: “IRML—A Rule Specification Language for Intermediary Services”, Internet Draft, IETF, November 2001, available at http://search.ietf.org/internet-drafts/draft-beck-opes-irml-02.txt). The proposed standardized Intermediary Rule Markup Language (IRML) is an example of a rule language that can be used and other rule languages could be devised by those skilled in the art. A standardized rule language advantageously allows rule authors to specify rules for network edge services in a standard format. Thus, if a standardized language is used, rules can be distributed to different service platforms owned by different access providers in the same standard format. IRML is an application of the Extensible Markup Language (XML). Thus, the IRML syntax is governed by the rules of the XML syntax (see, e.g., T. Bray, J, Paoli, C. M. Sperberg-McQueen, and E. Maler, “Extensible Markup Language (XML) 1.0” (Second Edition), W3C Recommendation, W3C, October 2000), which is well known to those skilled in the art, and the IRML grammar is specified by a DTD, a Document Type Definition.

The rule engine 201 determines whether a specific service module 206 is to be invoked by matching HTTP header values in the response from a server against its set of rule patterns. Optionally, HTTP header values in the user's request for that response may be used in conjunction with HTTP values in the response to determine whether a service module 206 is to be invoked. Once the rule engine 201 has analyzed the response, and optionally the associated request from a client, and has determined that a specific service is to be applied to a server's response, one or more service modules 206 within the service execution environment 205 are invoked. As will be described, a service module 206 that is invoked for making additional context-specific information available to the user either generates some or part of this additional context-specific information itself or retrieves some or part of the additional context-specific information from a cache on the ISP network or from a server connected to the ISP network or the Internet.

Once the rule engine 201 has determined that a specific service for formulating the additional context-specific information is to be applied to that response to a user's request, the appropriate service module 206 is invoked. The invoked service module 206 is then provided with the corresponding request and response message streams. The service invocation dispatcher 203 performs these tasks. Specifically, the rule engine 201 notifies the service invocation dispatcher 203 whenever a service module 206 within the service execution environment 205 is to be invoked. Although all service modules 206 are shown local to the intermediary 200 in FIG. 2, it is possible, as illustrated in the first-noted article, that some service modules may be resident upon a dedicated service execution server, where the particular service is invoked. For this latter case, not shown in FIG. 2 but shown in the referred-to and incorporated article, the service execution dispatcher differentiates between local service modules and service modules on a remote server and directs the request and response message streams to the remote service execution server for processing.

The open API (Application Program Interface) 204 provides the interface from the service invocation dispatcher 203 to the service execution environment 205 containing the plural service modules 206. The open API 204 also provides the interface for accessing message properties including those that may be parsed by the rule engine from the response and optionally the associated request.

A service module 206, when invoked, analyzes the content of the response from the server. Depending upon this content analysis, a decision is made whether additional context-specific information is needed. If it is not needed, then the original response is returned to the requesting client. If there is a need for additional information, then the response is modified before it is returned through the open API 204, the service invocation dispatcher 203, and the rule engine 201, to the client. This modification is performed in a manner that does not transform the content of the original response, but still provides the user with the availability of the additional context-specific information. Thus, for example, the response returned to the client may be modified to include a hyperlink to a placeholder HTML file stored on a Web server address or the Web cache 202. Alternatively, as another example, the original response may be modified to include an additional frame or JavaScript that, when returned to the client, will cause the user's browser to automatically open a new window. With respect to the first example, the user will need to manually click on the provided hyperlink to retrieve the additional context-specific information. With respect to the second example, the additional context-specific information is automatically displayed in the new window or additional frame.

While the intermediary, in response to the original request, forwards the modified response to the requesting client almost immediately, the additional context-specific information that the service module 206 has determined to be appropriately associated with that response may not be available instantly. The additional context-specific information may need to be internally processed by the service module at the intermediary or at a remote execution server, or it may need to be retrieved from one or more content provider servers on the Internet. Thus, while the user at the client is visually or otherwise reviewing the response to his request returned to his browser, the additional context-specific information is being processed in the background and injected into the Web cache 202 at a placeholder address or stored as a Web page on an associated Web server at the placeholder hyperlink address. Thus, after the user reviews the original response to his request and decides that the additional context-specific information is of interest, that information is immediately available by clicking on the link on the modified Web page, thereby eliminating the latency that would otherwise be present if processing of this information were to first begin at that time. Alternatively, if the additional context-specific information is provided to a new window that is opened by the user's browser, or in an additional frame, the JavaScript in the modified response to the user's browser can provide for the new window or additional frame to be automatically refreshed after some predetermined interval to display the additional information.

As an alternative to providing a hyperlink on the original Web page to the context-specific information, or opening a new window or an additional frame, the intermediary could modify the original Web page to add the additional context-specific information to the untransformed information already present in the original Web page before it is forwarded to the client. This would, however, eliminate the advantage of being able to present the requested response to the user while the service module is generating or retrieving from other Web servers the additional context-specific information.

Regardless of how and where the additional context-specific information is presented to the user, the present invention advantageously enables the additional context-specific information to be generated and made available independent of the original Web page. Thus, no cooperation between the content provider of the original Web page and the intermediary is necessary in order to generate or retrieve the additional context-specific information. The user can decide upon the particular services that generate the context-specific information or the ISP can decide upon them on behalf of the user.

Once the additional context-specific information has been generated or retrieved and stored in the cache or on a Web server, it need only remain extant there temporarily. Thus, after some predefined period of time during which the user may or may not select to retrieve the information that has been made available, the information can be removed since its use is transitory to the user in association with the response to his original request. This period of time should be somewhat longer than the average time a user spends reading or working with a Web page.

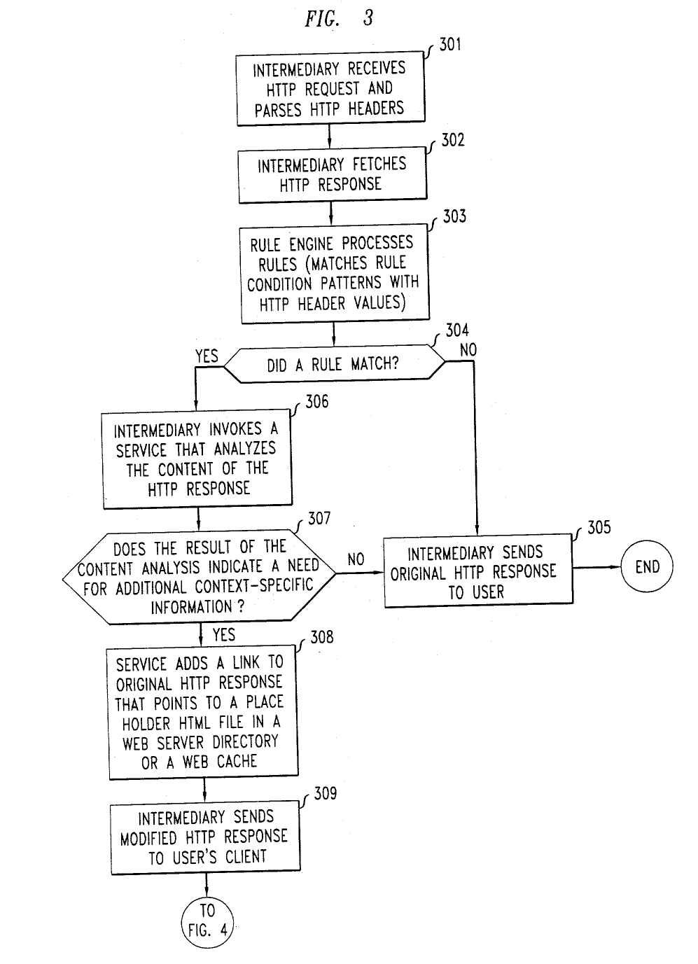

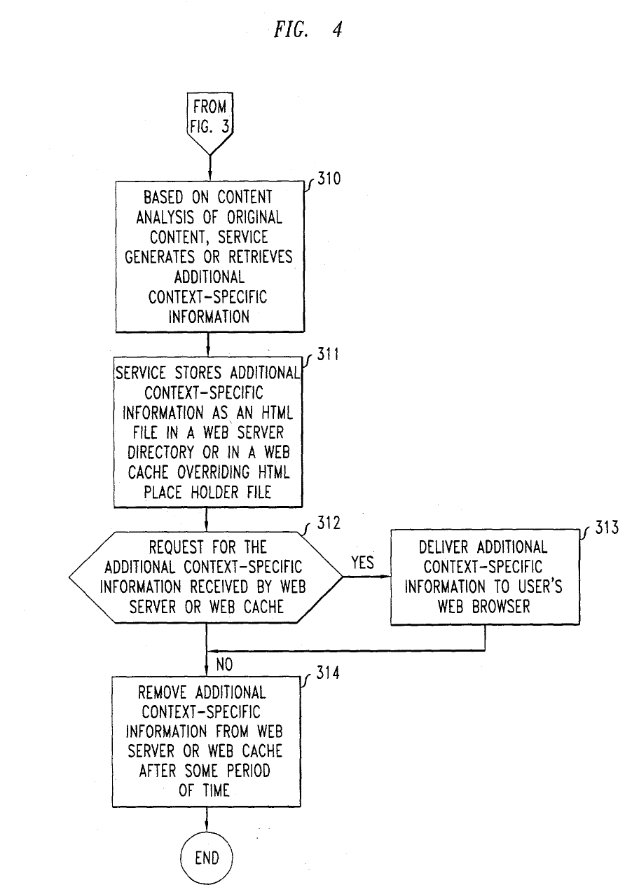

The flowchart in FIGS. 3 and 4 together illustrates the steps of providing additional context-specific information to a user in accordance with an embodiment of the present invention. At step 301, the intermediary receives an HTTP request and parses the HTTP headers for analysis by the rule engine. At step 302, the intermediary fetches the HTTP response, most likely an HTML Web page. At step 303, the rule engine processes the rules by matching rule condition patterns with the HTTP header values. At step 304, a determination is made whether a rule matches one or more HTTP header values. If it does not, then, at step 305, the intermediary sends the original HTTP response to the user's client, and the process ends. If one or more rules do match, then, at step 306, the intermediary invokes a service module that analyzes the content of the HTTP response. At step 307, a determination is made whether the result of the content analysis indicates a need for additional context-specific information. If not, at step 305, the intermediary sends the original HTTP response to the user, and the process ends. If the result of the content analysis does indicate the need for additional context-specific information, then, at step 308, the service module adds a hyperlink to the original HTTP response that points to a placeholder HTML file in a Web server directory or in a Web cache. (Alternatively, but not shown in the flowchart, the user's browser can be directed to open a new window or an additional frame, or the additional information can be sent to the user's browser together with the untransformed content of the original response). At step 309, the intermediary sends the modified HTTP response to the user's client, the modified response including the information in the original HTTP response. Meanwhile, in the background, at step 310, based on the content analysis of the original HTTP response, the service module that has been triggered by the rule engine generates or retrieves the additional context-specific information. At step 311, the service module stores this generated or retrieved additional context-specific information as an HTML file in a Web server directory or in a Web cache, overriding the HTML placeholder file. At step 312, a determination is made whether the Web server or the Web cache receives a request for this additional context-specific information. If yes, then at step 313, the additional context-specific information is delivered to the user's Web browser. Then, at step 314, this additional context-specific information is removed from the Web server or the Web cache after some period of time. If, at step 312, the Web server or the Web cache does not receive a request for the additional context-specific information, then, at step 314, the additional information is still removed after some period of time from the Web server or Web cache.

There are various examples of the types of services that can provide additional context-specific information. Two examples are presented below.

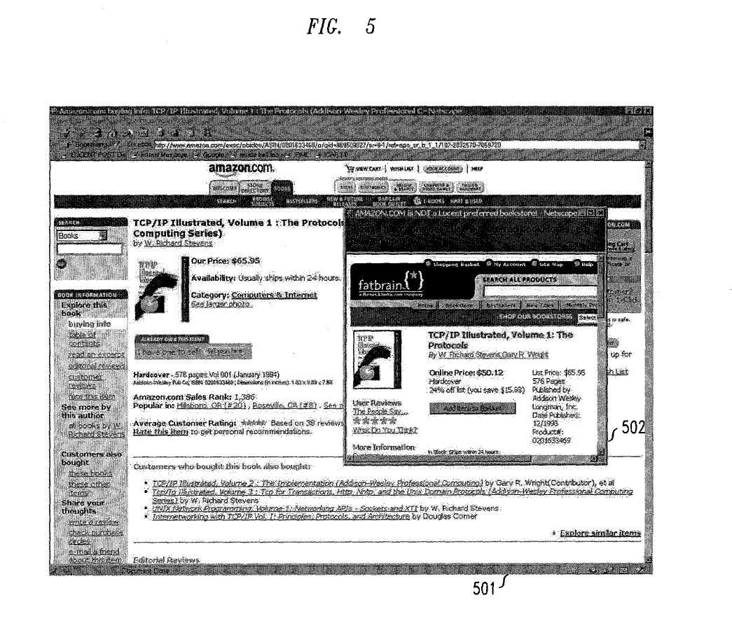

The first example is an online bookstore price comparison service. This service can be used to make Web users aware of an online bookstore that sells a specific book for less whenever a Web user shops for a book at an online bookstore that may not offer the lowest price. This service could obviously be applied to any other kind of product and online store. The service module providing this service would run on an intermediary and would monitor all requested Web pages. The service could be invoked, for instance, if the Web user goes to the product description page of an online bookstore. The service would then identify the featured product (possibly by using the ISBN code) and retrieve pricing information from alternative online bookstores. If the service finds a lower price, it could notify the user by opening a pop-up browser window containing the product description page of the particular online bookstore with the lowest price. If used in a corporate environment, such a service could remind employees to buy books at the company's preferred bookstore. The screenshot in FIG. 5 shows how this can be performed. A Web page 501 is delivered to a user's browser in response to a request to the amazon.com Web site. This page describes a particular book that the user is interested in purchasing. The service, by analyzing the content of this response automatically opens a pop-up window 502 that reminds the user to consider the company's preferred bookstore, fatbrain.com, and provides, in that window, the pricing information for that same book that has been retrieved from fatbrain.com's online Web site.

In other environments, this service may help online shoppers make informed choices. The principle behind this service is to analyze product description pages of different online stores as the user requests them. Once the featured product and the offered price have been identified on the requested product description page, the service can retrieve pricing information for the same product from other online stores and subsequently determine the online store that offers the same product at the lowest price.

A second example of the invention is a background translation service. The background translation service is based on the assumption that many users prefer to view Web pages in their original languages, but occasionally may want to see a translation for certain Web pages. This is likely to depend on the user's ability to understand the language used in the requested Web page and the complexity of the text. The approach of the background translation service takes advantages of these assumptions.

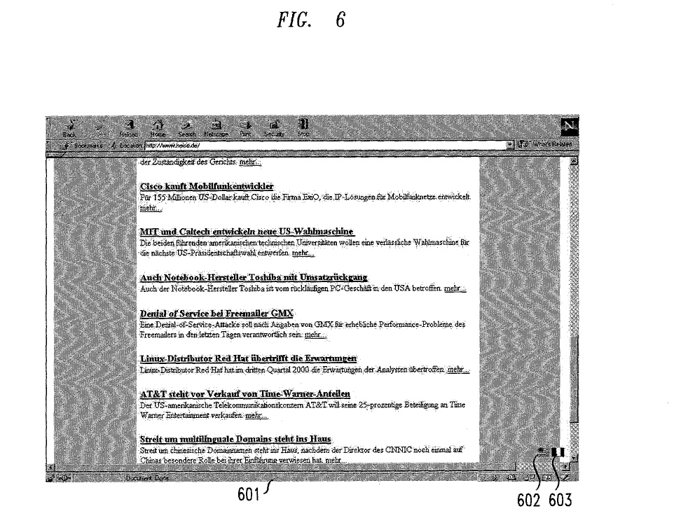

The background translation service could run on an intermediary including a caching proxy and requires an automatic translation software package. The translation software package could be installed as part of one of the service modules running on the intermediary or on a remote server. The rules engine within the intermediary invokes the background translation service whenever a user requests a Web page that contains text in a language other than the user's preferred language. The user's preferred language may be included in the HTTP header of each request sent by the browser running on user's client. The rules engine, when receiving back from a content provider's server, a response to a request, analyzes the content of the response, determines what language the response is in and whether the content is a type that can be translated, and then, for that request-response pair, determines whether the background translation service should be invoked. If the response is not of the type that can be translated, or is not in a language that needs or can be translated, the response is passed as is to the user's browser. If it is, the background translation service makes a small modification to the original page prior to delivering it to the user's client by adding a hyperlink to the original page that points to a (not yet existing) translation of this page. The hyperlink could be represented by a small image, such as a flag that floats over the original page at a fixed position, such as in the corner of the page. The appearance of this symbol then tells the user that a translation of this page is available and can be accessed by clicking on it. The screenshot in FIG. 6 shows an original Web page 601 delivered to a user in German, modified with an American flag 602 and French flag 603 in the bottom right corner of the page, which have been added by the background translation service to indicate that English and French translations of this page are available.

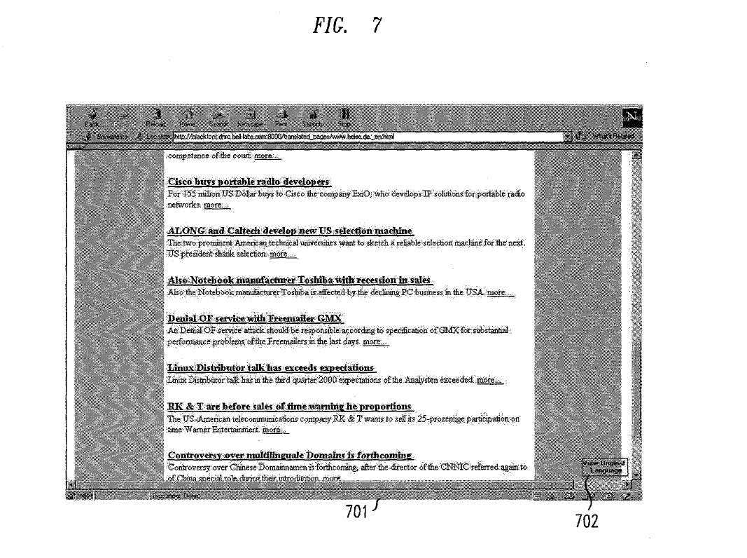

The modified original Web page is delivered to the user as soon as the links have been added. Immediately afterwards, however, the background translation service starts preparing the English and French translations of the page. The translations are then injected into the Web cache within the intermediary, or sent to a Web server, where they remain for a predefined period of time, which, as noted above, should be somewhat longer than the average time a user spends reading or working with a Web page. If the user then requests a translated version of the original Web page by clicking on either one of the flags, the translation is immediately available because it can be served from the Web cache or the Web server indicated by the hyperlink. The screenshot 701 in FIG. 7 shows an English translation of the original German-language screenshot in FIG. 6. It also shows a hyperlink 702 in the bottom right corner of the translation through which the user can return to the original Web page.

Advantageously, the background translation service translates a Web page while the user views the original Web page. Thus, there is no substantial delay between the user's Web request and the delivery of the requested Web page. A very short delay is introduced by adding a hyperlink to all requested pages that contain text in a language other than the user's preferred language that the service module can translate. Also, if the user decides after viewing the original page for some time that he does need a translation of this page, the translated page is available immediately and can be served from a nearby Web cache or from another Web server.

In some instances the user might request the translation of a Web page before or as it is being prepared. This could occur if the preparation of the translation takes longer than it takes the user to read the original page or if the user decides early that he wants to view a translated version of the page. In order to avoid an error situation, which would occur if the user requested a page that does not exist, prior to delivering the original page to the user, a standard placeholder page is inserted into the Web cache or the Web server where the translation will be stored. Having the same URL as the translation, the placeholder page informs the user that the original page has not yet been translated. It also contains a page refresh mechanism in order to periodically check for the translation. As soon as the translation has been prepared, it is injected into the Web cache or the Web server, overriding the placeholder page.

Although the described embodiment of the invention assumes clients are connected to an ISP over a hard-wired network using HTML-formatted Web pages, the invention is not so limited and could also be used with other types of clients such as wireless users or PDA users using other protocols and other content types such as WML pages. The present invention could therefore also be used to analyze responses to requests from Web servers that are formatted using PDF or other formats in order to determine whether additional context-specific information needs to be made available to the requesting user at a client of any type. Furthermore, although the method of the present invention is described above as being performed at an intermediary at the edge of an ISP network, the invention can be practiced anywhere in the path between and including the endpoints between the client and the server providing the original response to the user's request. Thus, for example, it could be performed at the user's client or elsewhere within the ISP network, or in the path between the ISP network and the response-providing server. The invention is most likely implemented in software code.

The foregoing merely illustrates the principles of the invention. It will thus be appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It will be further appreciated by those skilled in the art that the block diagrams herein represent conceptual views embodying the principles of the invention. Similarly, it will be appreciated that the flowchart represents various processes that may be substantially represented in computer readable medium and so executed by a computer or processor, whether or not such computer or processor is explicitly shown.

The invention claimed is:

1. A method comprising:
receiving a response to a user's request from a client;
determining from the content of the response whether additional context-specific information is needed;
if it is determined that additional context-specific information is needed, obtaining the additional context-specific information; and
providing to the client the response to the user's request without transforming its contents together with an indication that the additional context-specific information is available.

2. The method of claim 1 wherein the additional context-specific information is obtained while the response to the user's request is being provided to the client.

3. The method of claim 1 wherein the additional context-specific information is provided to the client together with the untransformed contents of the response to the user's request.

4. The method of claim 2 wherein the indication that the additional context-specific information is available is a hyperlink on a Web page that contains the untransformed contents of the response to the user's request.

5. The method of claim 1 wherein the indication that the additional context-specific information is available is a new window or an additional frame that displays the additional context-specific information in a browser running on the client.

6. The method of claim 2 wherein the additional context-specific information is obtained by generating it or retrieving it from one or more Web servers.

7. The method of claim 6 wherein the additional context-specific information is stored in a Web server or a Web cache.

8. The method of claim 7 further comprising creating a placeholder in the Web cache or the Web a server for the additional context-specific information while the additional context-specific information is being generated or retrieved.

9. The method of claim 8 wherein the placeholder is automatically replaced with the additional context-specific information after it has been generated or retrieved.

10. The method of claim 7 further comprising removing the additional context-specific information from the Web cache or Web server where it is stored after a predefined time interval.

11. The method of claim 1 wherein the determination whether additional context-specific information is needed is made based on the user's request and the content of the response to the request.

12. A method of claim 1 wherein the content of the response comprises information about a product or a service and the additional context-specific information relates to purchasing information related to the product or service.

13. The method of claim 11 wherein the content of the response comprises information in a language other than one or more preferred languages of the user that are indicated in the request, and the additional context-specific information is a translation of the information in the response to one or more of the user's preferred languages.

14. A method comprising:
receiving a request from a user's client;
fetching a response to the request from a content provider's Web server;
analyzing the content of the response to determine whether additional context-specific information is needed;
if additional context-specific information is determined to be needed, generating or retrieving the additional context-specific information;
modifying the response to the request without transforming its contents to indicate the availability of the additional context-specific information; and
sending the modified response to the user's client.

15. The method of claim 14 wherein the additional context-specific information is generated or retrieved in parallel with sending the modified response to the user's client.

16. The method of claim 14 wherein the additional context-specific information is sent to the users client together with the untransformed contents of the response to the request.

17. The method of claim 15 wherein the modified response comprises a hyperlink on a Web page that contains the untransformed contents of the response to the request.

18. The method of claim 14 wherein the additional context-specific information is delivered to the client in a new window or an additional frame that is opened in a browser running on the client.

19. The method of claim 15 wherein the additional context-specific information is stored in a Web server or a Web cache.

20. The method of claim 19 further comprising creating a placeholder in the Web cache or the Web server for the additional context-specific information while the additional context-specific information is being generated or retrieved.

21. The method of claim 20 wherein the placeholder is automatically replaced with the additional context-specific information after is has been generated or retrieved.

22. The method of claim 19 further comprising removing the additional context-specific information from the Web cache or Web server where it is stored after a predefined time interval.

23. The method of claim 14 wherein the user's request and the content of the response are analyzed to determine whether additional context-specific information is needed.

24. A computer readable media tangibly embodying a program of instructions executable by a computer to perform a method, the method comprising:
receiving a response to a user's request from a client;
determining from the content of the response whether additional context-specific information is needed;
if it is determined that additional context-specific information is needed, obtaining the additional context-specific information; and
providing to the client the response to the user's request without transforming its contents together with an indication that the additional context-specific information is available.
